(19) United States
(12) Patent Application Publication
(10) Pub. No.: US 2006/0252628 A1
(43) Pub. Date: Nov. 9, 2006

(54) Polarizing glass and manufacturing method of the same

(75) Inventors: Masahiro Ichimura, Niigata (JP); Yuichi Aoki, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/414,754

(22) Filed: Apr. 28, 2006

Related U.S. Application Data
(60) Provisional application No. 60/677,733, filed on May 4, 2005.

(51) Int. Cl. C03C 10/16; C03B 23/00

(52) U.S. Cl. 501/3; 65/33.3; 65/102

(57) ABSTRACT

High-efficient polarizing glasses which are used in a pair for isolators. The polarizing glass which includes elongated metal particles oriented uniquely and distributed therein is provided. When extinction ratio is measured at several points in the polarizing glass without rotating the polarizing glass, the extinction ratio is 50 dB or more, and the distribution of the extinction ratio is 5 dB or less.

### CROSS REFERENCE TO RELATED APPLICATION

The present application claims priority from a U.S. Provisional Application No. 60/677,733 filed on May 4, 2005, the contents of which are incorporated herein by reference.

### BACKGROUND OF THE INVENTION

1. Field of the Invention

The present invention relates to polarizing glasses and a manufacturing method of the same.

2. Related Art

Polarizing glasses are used for polarized wavelength dependent optical isolators in near infrared region. The optical isolator comprises a magnetic garnet film and two polarizing glasses between which the magnetic garnet film is sandwiched. The optical isolator allows the incident light emitted from a light source of a laser diode (LD) to be transmitted, and cuts off the light returning to the LD.

Polarizing glasses have two important optical properties; the extinction ratio and the tilt of polarization axes. The extinction ratio is related to the dichroic property of elongated metal particles. The wavelength at which the dichroic property appears most obviously, that is the center wavelength (CWL), depends on the aspect ratio of the elongated metal particles. The aspect ratio stands for the ratio of the major axis to the minor axis of the elongated metal particle. To obtain higher extinction ratio at the desired wavelength, the polarizing glass should include more elongated metal particles having the aspect ratio which provides the same CWL as the desired wavelength. It is the easiest way to increase the number of the elongated particles that the reducing temperature and time for hydrogen reduction process are adjusted so that the elongated metal halide particles are reduced as much as possible to be elongated metal particles. The hydrogen reduction process isn't complicated. If the elongated metal halide particles are included a lot in the elongated glass the extinction ratio increases easily.

The tilt of polarization axis indicates the relative tilt of major axes of the elongated metal particles. If the tilt is small the major axes of particles are oriented in an almost unique direction, which is optically useful. The relationship between extinction ratio and the major axis can be explained by the dichroism. The dichroic property is the remarkable difference in spectral absorption coefficients between the major and minor axes of the elongated metal particle. The light having the plane of polarization which is parallel to the major axis is mostly absorbed, and the light having the plane of polarization which is perpendicular to the major axis is hardly absorbed. The extinction ratio is the ratio of the transmitted light whose plane of polarization is perpendicular to the major axis to the transmitted light whose plane of polarization is parallel to the major axis. The major axis, therefore, very important factor in considering the extinction ratio. The extinction ratio is usually measured by rotating a polarizing glass for the purpose of the fine adjustment to make the major axis parallel or perpendicular to the plane of polarization of the transmitted light, which gives a higher extinction ratio, for example, over 50 dB in every measurement point in the polarizing glass.

For the polarizing glasses used in optical isolators, two pieces of the polarizing glasses in about 10-square-mm are laminated as maintaining the relative angle between polarization axes at 45 degrees, and the lamination of the polarizing glasses is cut in about 1-square-mm. This makes it difficult to accomplish such fine adjustment for increasing the extinction ratio of the polarizing glass.

It is easier, however, to increase the extinction ratio of the polarizing glass, for example, in 10-squre-mm before the lamination. As shown in FIG. 9, using the polarizing glasses which have a high extinction ratio can assure the sufficient extinction ratio even after being cut into, for example, about 1-squre-mm. FIG. 9 shows the relationship between the extinction ratio in vertical axis, and the measurement points on the polarizing glass in horizontal axis. The rotating angle of the polarizing glass is finely adjusted so that the extinction ratio is highest at the center point, or the zero point. At the other measurement points, the extinction ratio is measured without such fine adjustment, or rotation. Without such fine adjustment or rotation, the extinction ratio is uneven in the polarizing glass.

The reason of this may be the major axes of the elongated metal particles in the polarizing glass have relative angles, in other words, the tilts of the polarization axes are large. If, however, the relative angles between major axes are made small, and the tilts of polarization axes are made between 0.5 degrees and 0.4 degrees, the extinction ratio remains to be uneven as shown in FIG. 10.

The inventors made the polarizing glass having the tilt of polarization axis of 0.35 degrees or less, and measured the extinction ratio of the polarizing glass without any fine rotating adjustment. The difference between the maximum and minimum values of resulted extinction ratio is 5 dB or less. Precise research on the polarizing glass by the inventors found the width of the elongated glass constant. If the elongated glass has changed to be tapered, the elongated metal particles included in the elongated glass are tilted following the tapered shape. The inventors concluded that not only the relative angles which the elongated metal particles originally have but also the dependence on the tapered shape of the elongated glass causes the large tilt of polarization axis in the polarizing glass.

The inventors disclosed a method to improve the property of the polarization axis in Japanese laid-open patent 2004-224660. According to the method, it is disclosed that when a glass preform is heated, the temperature distribution in an electric furnace is controlled optimally so that the tilt of polarization axis will be small. The method was further improved and the better temperature distribution was found out, but the tilt of polarization axis couldn't drop to 0.35 degrees or less.

### SUMMARY OF THE INVENTION

To solve the above problem, according to the first embodiment of the present invention, a polarizing glass including elongated metal particles which are oriented in a unique direction and dispersed therein is provided. The polarizing glass has the extinction ratio of 50 dB or more when it is measured in several points therein without being rotated, and the distribution of the extinction ratio, which may be caused by the tilt of polarization axis, is 5 dB or less.

It is preferred that the orientation angle distribution of the elongated metal particles resides within a range of 0.0206 degrees/mm.

According to the second embodiment of the present invention, a manufacturing method of a polarizing glass including elongated metal particles which are oriented in a unique direction and dispersed therein includes; a preparing process in which a strip of mother glass including precipitated metal halide particles is prepared; and an elongating process in which the mother glass is heated by heaters put therearound, applied a predetermined force and drawn by a drawing means put outside in the longitudinal direction thereof so that the metal halide particles therein are elongated. In the elongating process, the mother glass is drawn as keeping the width of the resulted elongated glass constant.

In the elongating process, when the elongated glass is drawn, the angle of one side edge of the elongated glass to the drawing means drawn direction is smaller than 0.075 degrees. Especially, in the elongating process, it is preferred that the angle of one side edge of the elongated glass to the drawing means drawn direction is smaller than 0.01 degrees.

In the elongating process, the drawing means may include two rollers which hold the elongated glass between them and are synchronized and rotated mechanically. In the elongating process, the supply amount of the mother glass may be increased and the rotating rate of the rollers may be raised so that the width of the elongated glass will be more constant.

In the elongating process, the rotating rate of the rollers may be raised and the temperature of the heaters may be also raised so that a certain stress will be applied to the mother glass.

The above description of the present invention doesn't cite all the features of the present invention. The sub-combinations of these features may also be inventions.

According to the present invention, when the extinction ratio of the polarizing glass is measured at several points without rotating the polarizing glass, the extinction ratio is 50 dB or more, and the distribution of the extinction ratio is 5 dB or less so that the highly-efficient polarizing glass can be provided and applied to isolators, in which two pieces of the polarizing glasses are assembled. In the polarizing glass, the distribution of orientation angle of the elongated metal particles is within the range of 0.0206 degrees/mm. For example, in the about 17 mm wide polarizing glass, the difference in the orientation angle of each elongated metal particle is 0.35 degrees or less, which provides the high-efficient polarizing glass.

According to the present invention, in the elongating process, the constant width of the elongated glass, as well as the unique relative tilt of major axes of the elongated metal particles included in the polarizing glass can decrease the tilt of polarization axis.

In the elongating process of the present invention, the rotating rate of the two mechanically synchronized rollers is controlled to draw and elongate the elongated glass, which can allow the elongated glass to have a constant width. In the elongating process of the present invention, the stress applied to the glass preform is controlled by the heater temperature or both the heater temperature and the roller rotating rate, which can allow the elongated glass to have a constant width.

### BRIEF DESCRIPTION OF THE DRAWINGS

FIG. 1 shows a structure of the elongating apparatus 100 used in the elongating process of the present embodiment.

FIG. 2 shows a structure of the drawing means 40.

FIG. 3 is a schematic view of how the metal halide particles 22 are elongated.

FIG. 4 is a partially enlarged view of the FIG. 3.

FIG. 5 shows the tilted polarization axes of the first embodiment.

FIG. 6 shows the extinction ratios of the first embodiment.

FIG. 7 shows the tilted polarization axes of the first comparative example.

FIG. 8 shows the extinction ratios of the first comparative example.

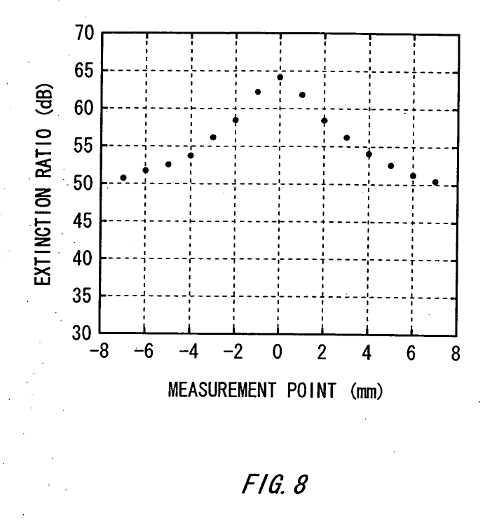

FIG. 9 shows the extinction ratios of the prior art example.

FIG. 10 shows the extinction ratios of the prior art example.

### DETAILED DESCRIPTION OF THE INVENTION

The following description explains the present invention with embodiments. The embodiments described below do not limit the invention claimed herein. All of the combinations described on the embodiments are not essential to the solutions of the present invention.

The manufacturing method related to the embodiment of the present invention includes; a preparing process in which a material glass is melted to make a mother glass; a precipitating process in which the mother glass is treated with heat to be precipitated metal halide particles therein; a elongating process in which the mother glass is drawn as maintaining the constant width thereof and elongated to be an elongated glass; and a reducing process in which the elongated glass is treated with heat to be reduced the metal halide included in the elongated glass, which provide a polarizing glass. The metal halide is, for example, selected from AgCl, AgBr, CuCl, and a combination thereof.

In the reducing process, the metal halide is reduced to metal, which provides the polarizing glass through which the incident light polarized with a certain polarization direction is transmitted.

In the elongating process, the mother glass including the metal halide particles which are precipitated in the precipitating process is formed into a strip of glass preform, then the glass preform is heated with the heaters and elongated so that the metal halide particles are elongated, which provide the elongated glass including the elongated metal halide particles.

When the glass preform is elongated, a predetermined stress is applied to the glass preform.

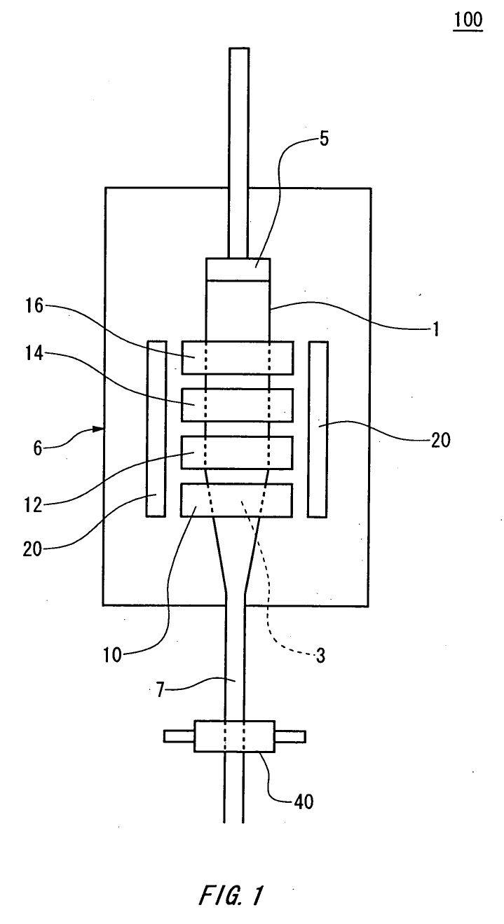

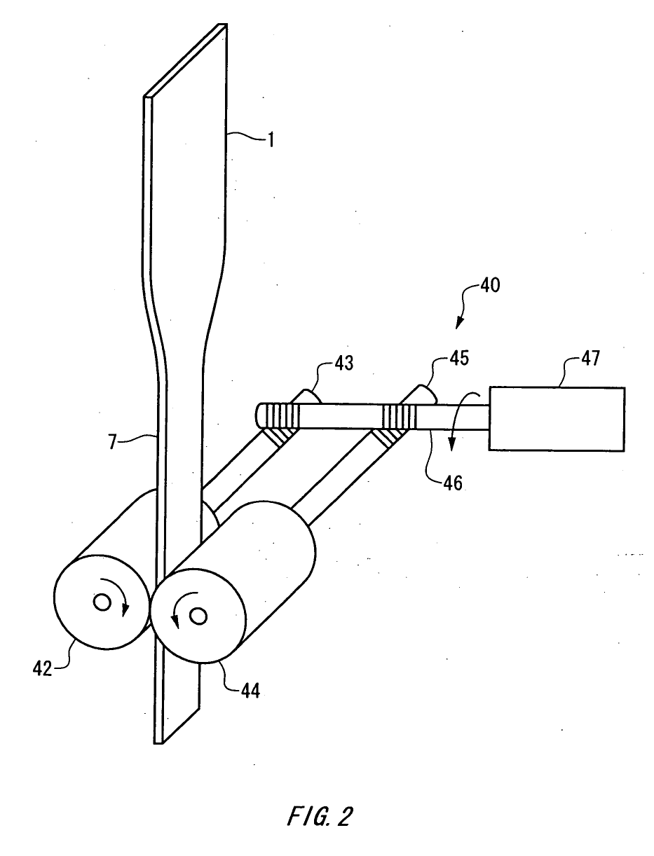

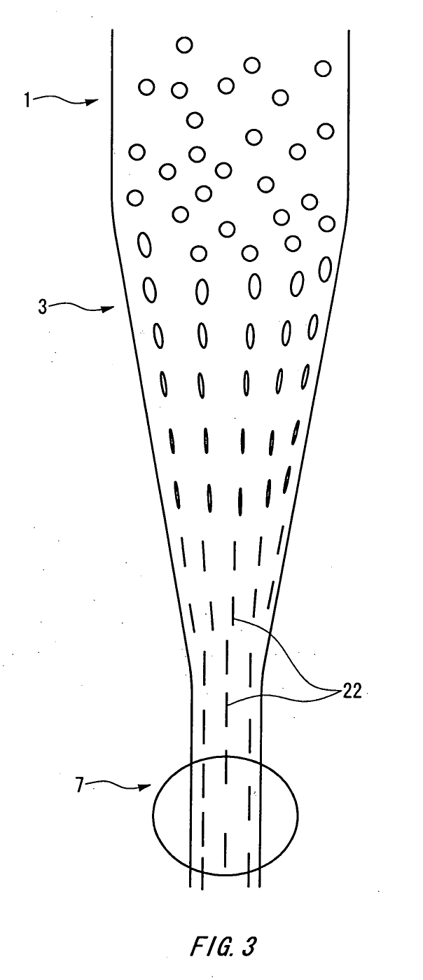

FIG. 1 shows a structure of the elongating apparatus 100 used in the elongating process of the present embodiment. FIG. 2 shows a structure of the drawing means 40. FIG. 3 schematically shows how the metal halide particles 22 are elongated. The elongating apparatus 100 includes; an electric furnace 6; a glass holder 5 which is set in the electric furnace 6; various types of heaters 10, 12, 14, 16 and 20 which are also set in the electric furnace 6; and drawing means 40 which is set below the various types of heaters along the longitudinal direction of the glass preform 1.

The drawing means 40 shown in FIG. 2 includes; a pair of rollers 42 and 44 between which the elongated glass 7 is sandwiched; driven shafts 43 and 45 which are rotated integrally with the pair of the rollers 42 and 44 respectively; a driving shaft 46 which rotates the driven shafts 43 and 45 synchronously mechanically; and a motor 47 which gives rotary driven force to the driving shaft 46. In the system shown in FIG. 2, the driven shafts 43 and 45 have respective spiral gears, in which the gear pitch is equal to each other, and the driving shaft 46 has gears engaging to the spiral gears.

In the elongating process, the glass preform 1 is fixed by the glass holder 5, heated by the various types of heaters set therearound, and drawn by the drawing means 40 in the longitudinal direction thereof.

In the present embodiment, the glass holder 5 holds the one longitudinal end of the glass preform 1 and moves downward slowly, while the drawing means 40 set below the heaters holds the other longitudinal end of the glass preform 1 and draws the glass preform 1 downward. The present embodiment is described below referring to FIG. 1. The glass preform 1, however, doesn't have to be drawn downward. For example, the glass holder 5 may hold the bottom end of the glass preform 1, and the drawing means 40 set above the heaters may hold the upper ends of the glass preform 1 to draw the glass preform 1 upward.

The glass preform is heated by the various types of heaters 10, 12, 14, 16 and 20, which are set around the glass preform 1. The heaters include; a main heater 10 which is set in front of the strip of the glass preform and heats near the center of the elongated part 3 where the glass preform 1 horizontally shrinks; side heaters 20 which set in the sides of the elongated part 3 and heats the side surfaces of the elongated part 3; and auxiliary heaters 12, 14, and 16 which set in certain intervals above the main heater 10.

The main heater 10 and the auxiliary heaters 12, 14, and 20 are a little wider than the glass preform 1. The plurality of heaters 10, 12, 14, 16, and 20 are separately controlled their powers. This allows the glass preform 1 to be heated with a temperature distribution which is appropriate to be elongated. The glass preform 1 is, therefore, heated with the temperature distribution so that the glass preform 1 is well elongated and the metal halide particles are well elongated, which is resulted from elongating the glass preform 1. The upper part of the elongated part 3 is gradually heated by the auxiliary heaters 12, 14, and 16.

After the glass preform 1 is elongated in the elongating process, the width of the elongated glass 7 depends on the amount of the supplied glass preform 1 and the amount of the drawn glass preform 1. The relationship between these is complicated because it's changed by the glass viscosity and the applied stress. The inventors experimentally found the amount of supplied glass per unit of time can be expressed in the following equation; Vₚ×Tₚ×Wₚ=Vₑ×Tₑ×Wₑ where Vₚ is the feed rate of the glass preform (mm/min), Tₚ is the thickness of the glass preform (mm), Wₚ is the width of the glass preform (mm), Vₑ is the draw rate of the elongated glass (mm/min), Tₑ is the thickness of the elongated glass (mm), and We is the width of the elongated glass (mm).

As described above, it is preferred after the elongating process the width of the elongated glass 7 is constant. The elongated glass 7 and the glass preform 1 change with an approximate scaling relationship, which make it difficult to control either thickness or width. Controlling the feed rate of the glass preform 1 and the draw rate of the elongated glass 7 allows controlling the thickness and width of the elongated glass 7 so that the width of the elongated glass 7 becomes constant.

In this case, to decrease parameters to be controlled, it is preferred one of the feed rate and the draw rate is fixed, and the other is controlled.

The rate parameter which can be changed more widely is able to be controlled in a wider range. In the present embodiment, the feed rate of the glass preform 1 is within the range from 0 to 10 mm/min, and the draw rate of the elongated glass 7 is within the range from 0 to 150 mm/min. It is preferred, therefore, to control the draw rate of the elongated glass 7 or the rotating rate of rollers 42 and 44. This allows the elongated glass 7 to efficiently have a constant width. If the glass preform 1 is left not to be drawn a lot, the rollers 42 and 44 are rotated faster.

This allows the elongated glass 7 to have a more constant width. The elongated glass 7 having a constant width can provide the polarizing glass whose extinction ratio is distributed in a smaller range.

The two rollers 42 and 44 are synchronized and rotated mechanically. Each of the rollers 42 and 44 applies the stress of 1 Kg/cm² or more to each other through the elongated glass. Even if the glass viscosity is 1×10¹⁰ to 1×10¹² poise in order to apply the stress of 300 Kg/cm² or more to the glass preform 1 in the elongating process, the rollers 42 and 44 are prevented from idle running against the elongated glass. This allows the elongated glass 7 to have a more constant width.

High extinction ratio can be obtained by keeping applying a constant stress while elongating the glass preform 1. As described above, in the present embodiment, the rotating rate of the rollers 42 and 44 or the drawn rate of the elongated glass 7 is controlled to allow the elongated glass to have an constant width. When the draw rate changes, the stress applied to the glass preform 1 will be changed.

For example, if the feed rate of the glass preform 1 and the temperature of the heaters are constant, the higher the drawn rate becomes, the larger the stress becomes, and the lower the drawn rate becomes, the smaller the stress becomes. In the present embodiment, both the draw rate of the elongated glass 7 and the temperature of the heaters are controlled so that the elongated glass can have a high extinction ratio and a constant width. If the rotating rate of the rollers 42 and 44 increases, the temperatures of the various types of heaters 10, 12, 14, 16, and 20 are raised up. This allows the constant stress to be applied to the glass preform 1.

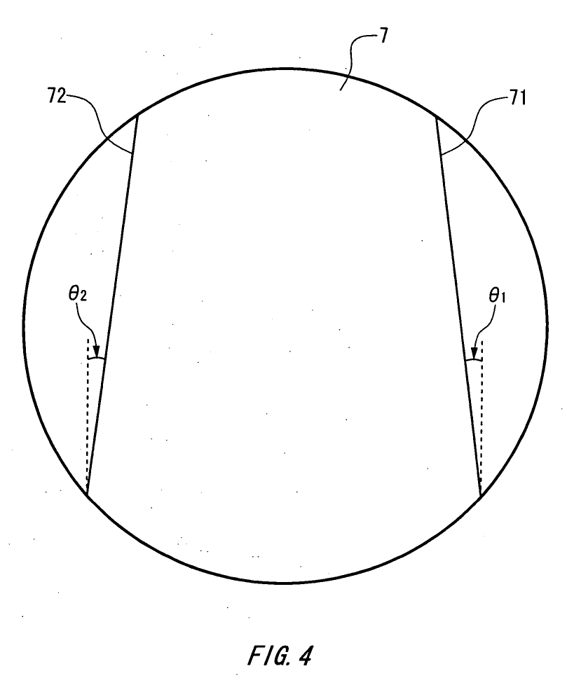

FIG. 4 is an enlarged view of the elongated glass 7. In FIG. 4, the tilts of the side edges of the elongated glass 7 are exaggerated against the elongated direction.

As shown in FIG. 4, the elongated glass 7 drawn by the drawing means 40 changes the width along the drawn direction, downwardly in the figure. On the whole, the part which is closer to the drawing means tends to be wider than the part which is closer to the glass holder 5. The angle of the one side edge 71 of the elongated glass 7 against the drawn direction is defined as the angle θ₁ shown in FIG. 4, and the angle of the other side edge 72 thereof against the drawn direction is defined as the angle θ₂. Each of the drawing means 40, the glass holder 5, and the glass preform 1 is almost symmetric, which allows the angles θ₁ and θ₂ to be deemed approximately equal. The following describes only the angle θ₁, and description of the angle θ₂ is omitted.

In the present embodiment, the angle θ₁ is maintained smaller than 0.075 degrees, while the elongated glass is drawn. Especially, it is preferred the angle θ₁ is maintained smaller than 0.01 degrees. The angle θ₁ can be controlled within the above range by such as the feed rate of the glass preform 1, the draw rate of the elongated glass 7, and the stress applied to the glass preform 1.

According to the present embodiment, the elongated glass 7 is reduced in the reducing process, which provides the high-efficient polarizing glass which is used for an isolator, in which two pieces of the polarizing glass are assembled. It also provides the high-efficient polarizing glass such as the about 17 mm wide polarizing glass which includes elongated metal particles having the orientation angle distribution within 0.35 degrees.

Besides the relative tilt between the elongated metal particles in the polarizing glass, the width of the elongated glass 7 is made constant in the elongating process so that the tilt of polarization axis over the width can be smaller.

In the elongating process of the present embodiment, the rotating rate of the two rollers 42 and 44, which are synchronized and rotated mechanically, are controlled while the elongated glass 7 is drawn so that the width of the elongated glass 7 can be constant.

In the elongating process of the present embodiment, the stress applied to the glass preform 1 is controlled by the temperature of the heaters, or both the temperature of the heaters and the rotating rate of the rollers 42 and 44 so that the extinction ratio and the width of the elongated glass 7 can be constant.

### EMBODIMENT 1

In the mother glass preparing process, the glass batch which includes, in weight percent, Li₂O: 1.8 wt %, Na₂O: 5.5 wt %, K₂O: 5.7 wt %, B₂O₃: 18.2 wt %, Al₂O₃: 6.2 wt %, SiO₂: 56.3 wt %, Ag: 0.24 wt %, Cl: 0.16 wt %, Br: 0.16 wt %, CuO: 0.01 wt %, Zr O₂: 5.0 wt %, TiO₂: 2.3 wt %, was pre-melted in a platinum melting pot at the temperature of about 1350 degrees centigrade. The pre-melted glass was broken into cullets which are as big as candies, then full-melted in the platinum melting pot at the temperature of about 1450 degrees, poured into a graphite mold to be cast, and annealed in an annealing furnace. Brought out from the annealing furnace, the mother glass was prepared.

In the precipitating process, after the nucleation in the mother glass at the temperature of 610 degrees in one hour, the mother glass was treated with heat at the temperature of 740 degrees in four hours on the condition of the grain growth. The heat treated mother glass was cut in the width of 70 mm, the length of 250 mm, and the thickness of 2 mm before the elongating process.

In the elongating process, the glass preform was put in the electric furnace and heated to make the glass viscosity from 1×10¹⁰ to 1×10¹¹ poise. The glass preform 1 was then sandwiched between the two rollers which are synchronized and rotated mechanically, and drawn to provide the elongated glass. In this process, the feed rate of the glass preform was 1.5 mm/min, and the pressure by the rollers pushing each other was about 1.5 Kg/cm², the stress applied to the glass preform was about 370 Kg/cm². The draw rate of the elongated glass was controlled as monitoring with a width measuring device which is set between the electric furnace and the rollers. The stress was also controlled by adjusting the temperature of the heaters in the electric furnace as monitoring the tension applied to the glass preform. The resulted elongated glass has the length of about 1 m, the width of the sample was 17.4 mm plus or minus 0.2 mm.

The sample elongated glass was annealed at the temperature of 480 degrees in two hours, then cut out, and reduced in hydrogen atmosphere at the temperature 470 degrees in four hours. The about 700 mm long polarizing glass was provided. The width distribution range was about 0.1 mm, and the angle θ₁ of one side edge of the polarizing glass against the drawn direction was about 0.01 degrees.

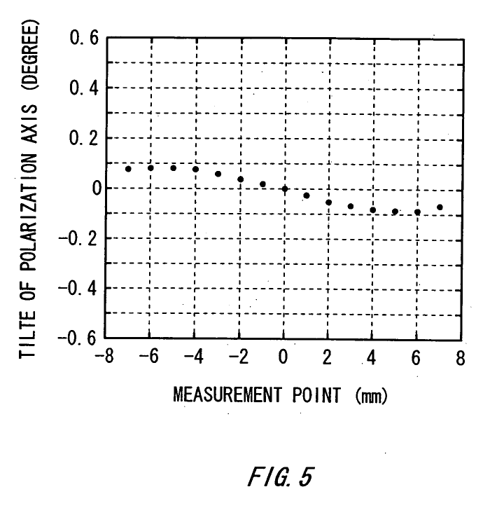

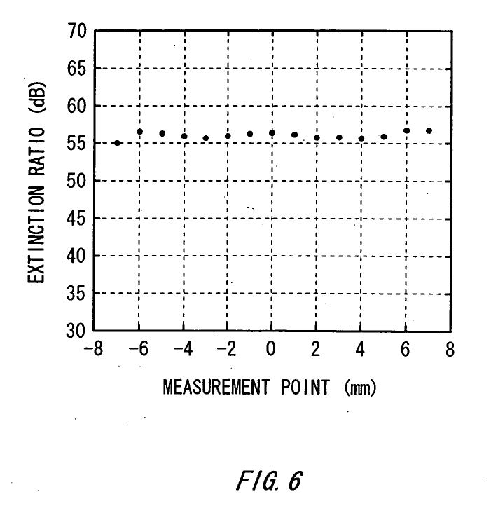

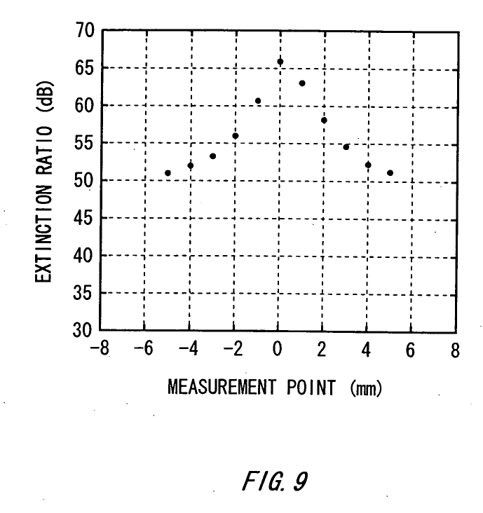

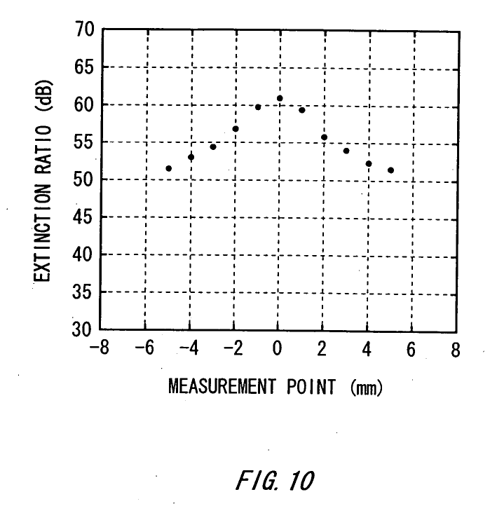

The tilt of polarization axis of the polarizing glass was distributed in the range of 0.2 degrees or less (plus or minus 0.1 degrees) as shown in FIG. 5. With fine adjustment, the maximum extinction ratio could be measured at the center of the width of the polarizing glass, then at several points in the left and right sides of the center, each extinction ratio was measured about 56 dB as shown in FIG. 6, which is different from wider distribution shown in FIGS. 9 and 10. In FIG. 6, the vertical scale indicates the extinction ratio, and the horizontal scale indicates the measurement point over the width whose center is defined as the center point (0).

### Comparative Example 1

In the preparing process and the precipitating process, the same glass preform as the first embodiment was prepared. In the elongating process, the glass preform was put in the electric furnace, and heated to make the glass viscosity 1×10¹⁰ to 1×10¹¹ poise. The glass preform was fed at 1.5 mm/min. One of the pair of rollers was rotated, and the other roller was pushed against the rotating roller to be rotated. The elongated glass was sandwiched between the pair of rollers, applied the stress of about 370 Kg/cm² and elongated to be an elongated glass. The draw rate of the elongated glass was controlled as monitoring with a width measuring device which is set between the electric furnace and the rollers. The stress was also controlled by adjusting the temperature of the heaters in the electric furnace as monitoring the tension applied to the glass preform.

While elongating, the roller sometimes ran idle, made it difficult to make the width of the elongated glass constant. The resulted elongated glass has about 0.9 m in length, 17.8 mm plus or minus 1.5 mm in width. The entire surface of the elongated glass had gentle bumps.

The elongated glass was annealed at the temperature of 480 degrees in two hours, then cut out, and reduced in hydrogen atmosphere at 470 degrees in four hours. The about 700 mm long polarizing glass was provided. The width distribution range was about 1.2 mm, and the angle θ₁ of one side edge of the polarizing glass against the drawn direction was about 0.1 degrees.

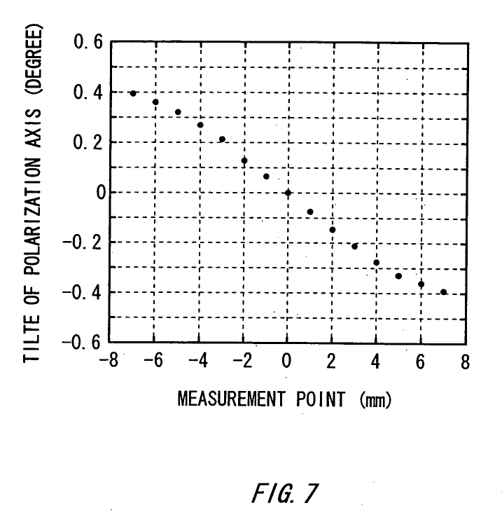

The tilt of polarization axes of the polarizing glass were distributed in the range of 0.8 degrees or less (plus or minus 0.4 degrees) as shown in FIG. 7. With fine adjustment, the maximum extinction ratio could be measured at the center of the width of the polarizing glass, then at several points in the left and right sides of the center. The results are shown in FIG. 6, which shows wider distribution values similarly shown in FIGS. 9 and 10.

### Comparative Example 2

In the preparing process and the precipitating process, the same glass preform as the first embodiment was prepared. In the elongating process, the glass preform was put in the electric furnace, and heated to make the glass viscosity 1×10¹⁰ to 1×10¹¹ poise. The glass preform 1 was then sandwiched between the two rollers which are synchronized and rotated mechanically, and drawn to provide the elongated glass. In this process, the feed rate of the glass preform was 1.5 mm/min, and the pressure by the rollers pushing each other was about 1.5 Kg/cm². The draw rate of the elongated glass was controlled as monitoring with a width measuring device which is set between the electric furnace and the rollers. The stress wasn't controlled. The stress, therefore, changed in the range between about 300 Kg/cm and 380 Kg/cm². The resulted elongated glass had about 1 m in length, 17.3 mm plus or minus 0.2 mm in width.

The elongated glass was annealed at the temperature of 480 degrees in two hours, and reduced in hydrogen atmosphere at 470 degrees in four hours. After reducing, the measurement found the extinction ratio changed by the applied stress. Especially, the part which was applied only the stress of 350 Kg/cm2 or less had the extinction ratio of 20 dB or less. The extinction ratio over the 1 m long sample could not be even.

The above description explaining the present invention with the embodiments does not limit the technical scope of the invention to the above description of the embodiments. It is apparent for those in the art that various modifications or improvements can be made to the embodiments described above. It is also apparent from what we claim that other embodiments with such modifications or improvements are included in the technical scope of the present invention.

What is claimed is:

1. A polarizing glass which includes elongated metal particles oriented uniquely and distributed therein, wherein when the extinction ratio is measured at several points therein without rotating the polarizing glass, the extinction ratio is 50 dB or more, and the distribution of extinction ratio is 5 dB or less.

2. The polarizing glass according to claim 1, wherein the distribution of orientation angle of said elongated metal particles in said polarizing glass is within the range of 0.0206 degrees/mm.

3. A manufacturing method of a polarizing glass including elongated metal particles which are oriented in a unique direction and dispersed therein includes;
a preparing process in which a strip of mother glass including precipitated metal halide particles is prepared; and
an elongating process in which said mother glass is heated by heaters put therearound, applied a predetermined force and drawn by a drawing means which is put outside in the longitudinal direction thereof so that said metal halide particles therein are elongated,
wherein in the elongating process said mother glass is drawn as keeping the width of the resulted elongated glass constant.

4. The manufacturing method of a polarizing glass according to claim 3, wherein in said elongating process, when said elongated glass is drawn, the angle of one side edge of said elongated glass to the drawing means drawn direction is smaller than 0.075 degrees.

5. The manufacturing method of a polarizing glass according to claim 4, wherein in said elongating process, the angle of one side edge of said elongated glass to the drawing means drawn direction is smaller than 0.01 degrees.

6. The manufacturing method of a polarizing glass according to claim 3, wherein in said elongating process, said drawing means includes two rollers which hold said elongated glass therebetween and are synchronized and rotated mechanically.

7. The manufacturing method of a polarizing glass according to claim 6, wherein in said elongating process, the left amount of the mother glass is increased and the rotating rate of said rollers is raised so that the width of said elongated glass is more constant.

8. The manufacturing method of a polarizing glass according to claim 6, wherein in said elongating process, the rotating rate of said rollers is raised and the temperature of said heaters is also raised so that a certain stress is applied to said mother glass.

9. The manufacturing method of a polarizing glass according to claim 7, wherein in said elongating process, the rotating rate of said rollers is raised and the temperature of said heaters is also raised so that a certain stress is applied to said mother glass.
